(19) United States
(12) Patent Application Publication
(10) Pub. No.: US 2020/0348716 A1
(43) Pub. Date: Nov. 5, 2020

(54) METHOD FOR CONFIGURING MASTER/SLAVE IN DOUBLE BOARD, AND BOARD THEREOF

(71) Applicant: HYOSUNG HEAVY INDUSTRIES CORPORATION, Seoul (KR)

(72) Inventor: Hyo Chul KWON, Suwon-si Gyeonggi-do (KR)

(21) Appl. No.: 16/957,315

(22) PCT Filed: Dec. 20, 2018
(86) PCT No.: PCT/KR2018/016396

§ 371 Date: Jun. 23, 2020

(30) Foreign Application Priority Data
Dec. 28, 2017 (KR) 10-2017-0183191

(51) Int. Cl. G06F 1/10; G06F 9/4401; G06F 7/58; G06F 1/26

(52) U.S. Cl. CPC G06F 1/10; G06F 1/26; G06F 7/588; G06F 9/4403

(57) ABSTRACT

A method for setting a duplexed board to a master or slave board during initial booting and the board. According to an embodiment of the present invention, a method of setting duplexed boards to master/slave includes simultaneously inputting power to first and second boards which are duplexed in initial booting; generating, by the first and second boards, clocks individually when the power is input, counting, by each of the first and second boards, a number of the generated clocks when the power is input; transmitting, by each of the first and second boards, the counted number of clocks to a counterpart board and receiving a number of clocks counted by the counterpart board from the counterpart board on each clock generated; and comparing, by each of the first and second boards, the numbers of clocks transmitted and received on each clock, setting the board itself to a master board when the number of clocks of the broad itself is greater than that of the slave board, and setting the board itself to a slave board when the number of clocks of the broad itself is less than that of the slave board.

### TECHNICAL FIELD

The present invention relates to a method for setting redundant boards, and particularly to a method for setting a duplexed board to a master or slave board during initial booting and the board.

### BACKGROUND ART

In general, a controller that controls an important facility is implemented with a redundancy scheme such that continuous control is achieved even in the event of a sudden failure. Recently, there have been increasing cases of implementing boards that perform important functions such as calculation boards or control boards in the controller with a redundancy scheme.

Korean Patent Publication No. 2000-0055954 and Korean Registration No. 0320149 disclose a technology in which, a slave board detects a fault through communication and switches to a master to operate as a master board when a master board of duplexed boards fails when operating.

However, these prior art documents disclose techniques for switching of a master/slave board during operation of the duplexed boards, and do not suggest a technique for setting master and slave boards during initial booting of the duplexed boards.

In addition, in order to set a master board and a slave board during the initial booting of the duplexed boards, the duplexed boards read out a register value of theirs counterpart board and determine whether to operate as a master, or read out information of an external dip switch determine whether to operate as a master/slave.

In this prior art, there are problems, a certain time is required for determination of a master/slave because the duplexed boards need to read out the information of the counterpart board, an operator setting error may occur during the operation of the dip switch, and a certain time is required to read out information of the dip switch. The required time may lead to a time delay of operation of the boards in which fast control is necessary.

### DISCLOSURE

### Technical Problem

The present invention has been proposed to solve the above-mentioned problems of the prior art, and an object of the present invention is to provide a method for setting a duplexed board to a master/slave board which, sets a duplexed board to a master/slave board using information stored internally in initial booting and the board.

In addition, another object of the present invention is to provide a method of quickly setting a duplexed board to a master/slave board through simple communication and the board.

### Technical Solution

In order to accomplish the above object, the present invention provides a high-pressure vessel for a vehicle, the high-pressure vessel including:

According to an embodiment, a method of setting duplexed boards to master/slave, the method includes simultaneously inputting power to first and second boards which are duplexed in initial booting; generating, by the first and second boards, clocks individually when the power is input; counting, by each of the first and second boards, a number of the generated clocks when the power is input; transmitting, by each of the first and second boards, the counted number of clocks to a counterpart board and receiving a number of clocks counted by the counterpart board from the counterpart board on each clock generated; and comparing, by each of the first and second boards, the numbers of clocks transmitted and received on each clock, setting the board itself to a master board when the number of clocks of the broad itself is greater than that of the slave board, and setting the board itself to a slave board when the number of clocks of the broad itself is less than that of the slave board.

According to an embodiment, the method may further include generating, by each of the first and second boards, a random number when the two numbers of clocks transmitted and received are equal to each other for a predetermined time as a result of the comparison; transmitting, by each of the first and second boards, a random number of the board itself to the counterpart board and receiving a random number generated by the counterpart board from the counterpart board; and comparing, by each of the first and second boards, the two random numbers that are transmitted and received and setting the board itself to a master board or a slave board.

According to an embodiment, each of the first and second boards may set the board itself to a master board when the random number generated by the board itself is greater than the random number of the counterpart board and set the board itself to a slave board when the random number generated by the board itself is less than the random number of the counterpart board.

According to an embodiment, each of the first and second boards may set the board itself to a master board when the random number generated by the board itself is less than the random number of the counterpart board and set the board itself to a slave board when the random number generated by the board itself is greater than the random number of the counterpart board.

According to an embodiment, the number of clocks has a digital value composed of 1 and 0, and the communication unit alternately transmits and receives the digital value of the number of clocks alternately with the counterpart board by one bit sequentially.

According to an embodiment, when the digital values of the two numbers of clocks are transmitted and received, the first and second boards set the master board and the slave board according to the following conditions:

when A=B=1 or A=B=0, setting of master/slave board is suspended,

when A=1, B=0, setting of the first board to a master board and the second board to a slave board is performed, and

when A=0, B=1, setting of the first board to a slave board and the second board to a master board is performed.

(A is a digital value of 1 bit transmitted to the counterpart board, and B is a digital value of 1 bit received from the counterpart board).

According to an embodiment, the control unit may transmit and receive a next digital value of 1 bit among the digital values of the number with the counterpart board through the communication unit and sets a master board or a slave board according to the conditions when A=B=1 or A=B=0.

According to an embodiment, a duplexed board includes a clock generator configured to generate a clock when power is supplied in initial booting; a clock counter configured to count a number of clocks generated by the clock generator; a communication unit configured to transmit the counted number of clocks to a counterpart board and receive a number of clocks of the counterpart board from the counterpart board on each clock; and a control unit configured to set, to a master board, a board having a larger number of clocks among the two numbers of clocks transmitted and received on each clock through the communication unit.

According to an embodiment, the communication unit may transmit the number of clocks of the board itself to the counterpart board on each clock generated by the clock generator.

According to an embodiment, the duplexed board may further include a random number generator configured to generate a random number, wherein the random number generator may generate a random number when the two numbers of clocks transmitted and received are equal to each other for a predetermined time, and the communication unit may transmit the random number to the counterpart board and receive a random number from the counterpart board, and the control unit may set a master/slave board by comparing the two random numbers transmitted and received.

According to an embodiment, the control unit may set a board which has generated a larger random number as a result of comparing the two random numbers, to a master board.

According to an embodiment, the number of clocks may have a digital value composed of 1 and 0, and the communication unit may alternately transmit and receive the digital value of the number of clocks alternately with the counterpart board by one bit.

According to an embodiment, when the digital values of the two numbers of clocks may be transmitted and received, the control unit may set a master and a slave board according to the following conditions:

when A=B=1 or A=B=0, setting of master/slave board is suspended,

when A=1, B=0, setting of the board itself to a master board is performed, and

when A=0, B=1, setting of the board itself to a slave board is performed.

(A is a digital value of 1 bit transmitted to the counterpart board, and B is a digital value of 1 bit received from the counterpart board).

According to an embodiment, the control unit may transmit and receive a next digital value of 1 bit among the digital values of the number with the counterpart board through the communication unit, and set a master board or a slave board according to the conditions when A=B=1 or A=B=0.

### Advantageous Effects

According to the present invention, the master/slave board is set by using clocks that are respectively counted by the duplexed boards in the control unit, thus achieving simple and quick setting.

In addition, according to the present invention, it is possible to set the master/slave board without additional configuration by installing the same software on the duplexed boards thus accomplishing an increase in the productivity of products and decreasing the possibility of malfunction.

### DESCRIPTION OF DRAWINGS

FIG. 1 is an exemplary view of a device to which duplexed boards according to an embodiment of the present invention is applied.

FIG. 2 is a block diagram of duplexed boards according to an embodiment of the present invention.

FIG. 3 is an exemplary diagram illustrating a process of transmitting digital values of numbers of clocks between boards according to an embodiment of the present invention.

FIG. 4 is a flowchart illustrating a method of setting duplexed boards to a master/slave boards according to an embodiment of the present invention.

### MODE FOR INVENTION OR BEST MODE

Hereinafter, embodiments of the present disclosure will be described in detail with reference to the exemplary drawings. In adding reference numerals to the components of each drawing, it should be noted that the same reference numerals are assigned to the same components as much as possible even though they are shown in different drawings. In addition, in describing the embodiment of the present invention, if it is determined that the detailed description of the related known configuration or function interferes with the understanding of the embodiment of the present invention, the detailed description thereof will be omitted.

In addition, in describing the components of the embodiments of the present invention, terms such as first, second, A, B, (a), and (b) may be used. These terms are merely intended to distinguish one component from another component, and the terms do not limit the nature, sequence or order of the constituent components. It should be noted that if it is described in the specification that one component is “connected,” “coupled” or “joined” to another component, the former may be directly “connected,” “coupled,” and “joined” to the latter or “connected”, “coupled”, and “joined” to the latter via another component.

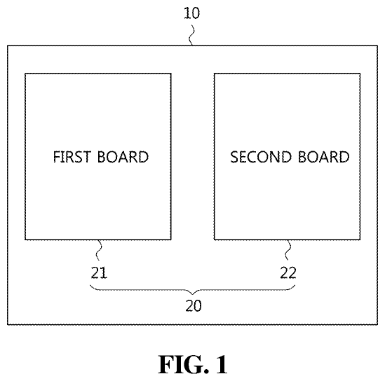

FIG. 1 is an exemplary view of a device to which duplexed boards according to an embodiment of the present invention is applied. Referring to FIG. 1, a device 10 to which duplexed boards 20 according to an embodiment of the present invention is applied includes a first board 21 and a second board 22 which are duplexed. Since the first board 21 and the second board 20 are configured with a redundancy scheme, the first board 21 and the second board 20 are configured with the same configuration (hardware) and the same function (software and program) as each other. The device 10 may be configured in various ways. For example, it may be a control device that controls a facilities or devices.

In addition, in the embodiment of the present invention, the first board 21 and the second board 22 are boards provided in a general control unit, and collectively refer to boards that perform various functions, such as a calculation board and a control board. In addition, in the present invention, the boards 21 and 22 are used as a concept including a device such as a control unit or a control module.

Furthermore, although the two boards 21 and 22 are shown as an example of the duplexed boards in the embodiment of the present invention, the present invention is not limited to this embodiment and may be configured by two or more boards according to a multiplexing manner. That is, the method of setting master/slave boards according to the present invention may be equally applied to multiple boards. Accordingly, in the present invention, duplexed boards will be described as an example for convenience of description.

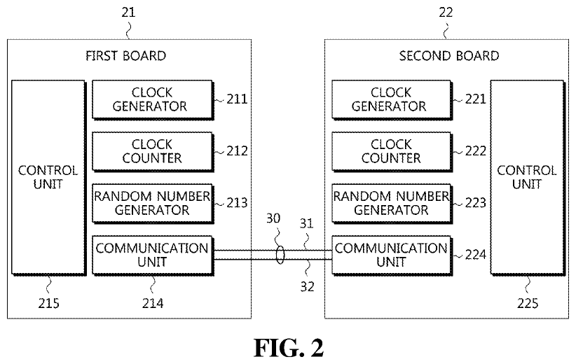

FIG. 2 is a block diagram of duplexed boards according to an embodiment of the present invention. As described above, since the duplexed boards 21 and 22 have the same configuration and functions, only the first board 21 will be described below.

In an embodiment of the present invention, the first board 21 includes a clock generator 211, a clock counter 212, a communication unit 213, and a control unit 214. Optionally, in another embodiment, a random number generator 215 may be further included.

The clock generator 211 periodically generates a predetermined clock when power is supplied by the initial booting of the board 21. Here, the power may be a starting voltage supplied from a power supply (e.g., SMPS) when booting a device in a state in which a power supply of the board 21 is turned off, specifically, in a state in which the device including the corresponding board 21 is turned off. When power is supplied to boot the device as described above, power is also supplied to the board 21. As such, when power is supplied to the board 21, the clock generator 211 immediately generates a clock at a predetermined cycle.

The clock counter 212 continuously counts the number of clocks periodically generated by the clock generator 211 and stores the number of clocks in an internal memory. The number of clocks is the number of times the clock has occurred, and is preferably counted and stored as a digital value consisting of 1 and 0. For example, a n-bit data value may be counted such as 1 time is counted as 1(1 bit), 2 times is counted as 10 (2 bits), 3 times is counted as 11 (3 bits), and 4 times is counted as 100 (3 bits) As another example, the number of bits may be fixed to N bits. For example, when the number of bits is composed of 8 bits, it may be composed of data values of 00000001 for one time, 00000010 for two times, 00000011 for three times, and 00000100 for four times.

The communication unit 213 transmits the number of clocks counted as described above to a counterpart board whenever a clock occurs and receives the number of clocks of the counterpart board from the counterpart board. That is, the first board 21 transmits the number of clocks counted by the first board 21 itself on each clock to the second board 22 and receives the number of clocks counted by the second board 22 from the second board 22. The transmission/reception of the number of clocks applies equally to the second board. That is, the second board 22 transmits the number of clocks counted by the second board 22 itself on each clock to the first board 21 and receives the number of clocks counted by the first board 21 from the first board 21. Preferably, the number of clocks counted on the current clock cycle is transmitted and received on the next clock cycle.

In this case, when the digital values of the numbers of clocks in the first and second boards 21 and 22 are transmitted and received between the first and second boards 21 and 22, the communication unit 213 transmits and receives one bit to and from the counterpart board alternately. For example, assuming that the first and second boards 21 and 22 both transmit and receive “5” which is the number of clocks, that is 1001 as a digital value with each other, the first board 21 transmits “1” and the second board 22 transmits “1” and the first board 21 transmits the next digital value “0”, and the second board 22 transmits its second digital value “0”. As described above, the digital values are alternately transmitted by one bit sequentially.

The communication unit 213 transmits the digital value through the differential communication lines 30 connected between the first and second boards 21 and 22. The differential communication lines 30 may support the first board 21 and the second board 22 to alternately transmit the digital values by one bit sequentially.

The control unit 214 sets the master/slave boards by comparing two numbers of clocks transmitted/received on each clock through the communication unit 213, sets a board of a larger number of clocks to the master board, and sets a board of a small number of clocks to a slave board. The setting of the master/slave board is to set a board having a larger number of clocks among the first and second boards 21 and 22 which are duplexed to a master board.

As described above, the two boards 21 and 22 which are duplexed are substantially the same board. That is, the two boards 21 and 22 are the same boards that have the same configuration and function and operates in substantially the same manner. However, even though the two boards 21 and 22 are the same, the performance of the two boards 21 and 22 may be slightly different when used for a long period of time. In the present invention, after the power is simultaneously applied to the two first and second boards 21 and 22, the two first and second boards 21 and 22 count the number of clocks individually and identify the number of clock of the counterpart board on each clock, making it possible to set the board of the larger number of clocks which is counted quickly to a master board.

Here, the control unit 214 compares the digital values of the two numbers of clocks and sets a master/slave board according to the following conditions. For convenience of description, assuming that the digital value of 1 bit transmitted to the second board 22 by the first board 21 is referred to as “A”, and the digital value of 1 bit received from the second board 22 by the first board 21 is referred to as “B”, when the relationship between A and B is A=B=1 or A=B=0, the setting of the master/slave board is temporarily suspended, when A=1 and B=0, the first board 21 is set to the master board, and when A=0 and B=1, the first board 21 is set to the slave board. In this case, when the first board is set to a master board, the second board is set to the slave board, and when the first board is set to the slave board, the second board is set to the master board.

Since each of the first and second boards 21 and 22 independently compares its own number of clocks with the number of clocks of the counterpart board, each of the first and second boards 21 and 22 may set the board itself to the master board when the number of clocks is greater than the number of clocks of the counterpart board and, in this case, the counterpart board may set the board itself to the slave board when the number of clocks of the board itself is less than the number of clocks of the counterpart board.

When A=B=1 or A=B=0 in the above example, the control unit 214 temporarily suspends the setting of the master/slave board. In this case, the next one bit of the digital value of the number of clocks is transmitted and received between two boards through the communication unit 213 in the same manner as above, and the master board and the slave board are set in the same manner according to the above conditions. The above process is sequentially performed on digital values until one the numbers of clocks of the two boards 21 and 22 becomes greater than the other on each clock.

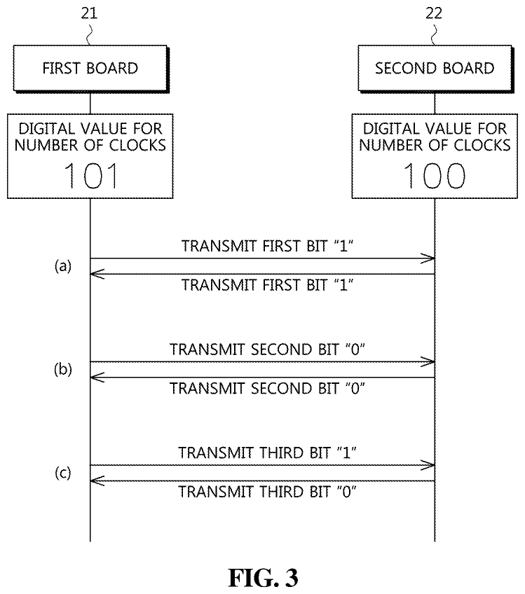

FIG. 3 is an exemplary diagram illustrating a process of transmitting digital values of numbers of clocks between boards according to an embodiment of the present invention. Referring to FIG. 3, for example, it is assumed that the digital value of the number of clocks counted in the first board 21 is 101 and the digital value of the number of clocks counted in the second board 22 is 100.

First, as shown in (a), when the first board 21 transmits the first bit “1” of its digital value 101 to the second board 22 through a first communication line 31 of the differential communication line 30, the second board 22 transmits the first bit “1” of its digital value 100 to the first board 21 through the second communication line 32. Accordingly, since the digital value 1 of the board itself and the digital value 1 of the counterpart board are equal to each other, the control units of the first and second boards 21 and 22 suspend setting of the master board.

Then, as shown in (b), the first board 21 transmits and receives the second bit 0 that is the next bit, and the second board 22 also transmits and receives the second bit 0 that is the next bit. Accordingly, since the two digital values transmitted and received are equal to each other, each control unit suspends the setting of the master board.

Then, as shown in (c), the third bit that is the next bit is transmitted and received. In this case, the first board 21 transmits “1”, and the second board 22 transmits “0”. Then, the control unit of the first board 21 sets the first board 21 itself to the master board because its own digital value is “1”, and the digital value of the second board 22, which is the counterpart board, is “0”. In this case, the control unit of the second board 22 sets the second board 22 itself to a slave board because its own digital value is “0” and the digital value of the first board 21, which is the counterpart board, is “1”.

As can be seen in this process, the first and second boards 21 and 22 exchange digital values of the numbers of clocks, counted by themselves, with each other by one bit, and the but are repeated until different digital values are generated. When the digital value comes out, the master/slave board is determined as above according to the result.

The random number generator 215 generates a random number. The random number generator 215 may generate a random number through a random number generating program. In this case, the first and second boards 21 and 22 each include a random number generator 215 equipped with the same random number generating program.

As described above, when the digits of the numbers of clocks of the two boards 21 and 22 are continuously equal to each other on each clock, the master board cannot be set and the function of the board cannot be performed. In order to prevent this, when the digits of the two numbers of clocks are continuously equal to each other for a preset time, the random number generator 215 generates a random number through a preset program.

The random number generated in this way is transmitted to the counterpart board by the communication unit 213, and the random number generated in the counterpart board is received from the counterpart board.

Accordingly, the control unit 214 compares two random numbers transmitted and received, that is, a random number generated by the board itself and a random number received from the counterpart board, and sets the board itself to a master board or a slave board according to the comparison result. In one example, when the random number generated by the board itself is greater than the random number of the counterpart board, each of the first and second boards 21 and 22 may set the board itself to the master board, and when the random number generated by the board itself is less than the random number of the counterpart board, each of the first and second boards 21 and 22 may set the board itself to the slave board, and in another example, on the contrary, when the random number generated by the board itself is less than the random number of the counterpart board, each of the first and second boards 21 and 22 may set the board itself to the master board, and when the random number of the board itself is greater than the random number of the counterpart board, each of the first and second boards 21 and 22 may set the board itself to the slave board. That is, according to the comparison of random numbers, it may be determined in advance that a board with a larger random number is set to a master or a board with a smaller random number is set to a master board.

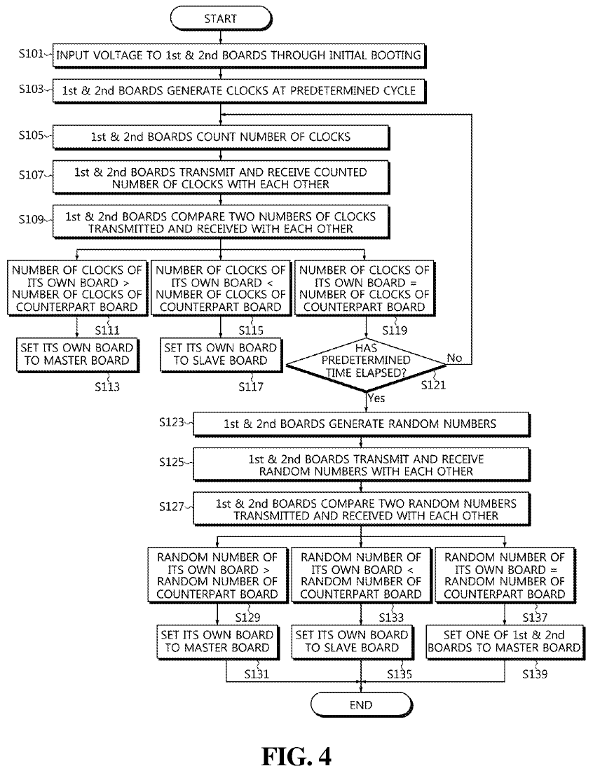

FIG. 4 is a flowchart illustrating a method of setting duplexed boards to master/slave boards according to an embodiment of the present invention. Referring to FIG. 4, in the method of setting duplexed boards to a master/slave boards according to the present invention, power is simultaneously input to the first board 21 and the second board 22, which are duplexed, through initial booting (S101). When power is supplied, each of the first and second boards 21 and 22 generates a clock (S103). Subsequently, each of the first and second boards 21 and 22 counts the number of clocks generated (S105).

Thereafter, each of the first and second boards 21 and 22 transmits and receives its counted number of clocks with the counterpart board on each clock (S107). That is, each of the first and second boards 21 and 22 transmits its counted number of clocks to the counterpart board and receives the number of clocks counted by the counterpart board from the counterpart board using the differential communication lines 30.

Subsequently, the first and second boards 21 and 22 compare the two numbers of clocks transmitted and received on each clock (S109). In this comparison, when the number of clocks of the board itself is greater than the number of clocks of the counterpart board (S111), each of the first and second boards 21 and 22 sets the board to a master board (S113) and, conversely, when the number of clocks of the board itself is less than the number of clocks of the counterpart board (S115), sets the board itslef to a slave board (S117).

When the two numbers of clocks are equal to each other (S119), the process proceeds to step S105 in the comparison (S109), each of the first and second boards 21 and 22 counts the number of clocks generated at the next cycle and repeatedly performs the steps to step S119. Also in this case, when the two numbers of clocks are equal to each other (S119), these steps are repeatedly performed until a predetermined time elapses (S121).

When a predetermined time has elapsed during the repetition of these steps (S121), random numbers are generated in the first and second boards (S123). The generation of the random number is performed by the random number generator 215 installed therein.

Subsequently, the first and second boards 21 and 22 transmit and receive their generated random numbers with each other through the differential communication line 30 (S125). That is, each of the first and second boards 21 and 22 transmits its random number to the counterpart board and receives the random number of the counterpart board from the counterpart board.

Accordingly, each of the first and second boards 21 and 22 compares two random numbers transmitted and received (S127), and when the random number of the board itself is greater than the random number of the counterpart board (S129), sets the board itself to a master board (S131), when the random number of the board itself is less than the random number of the counterpart board (S133), sets the board itself to a slave board (S135).

In this case, in another embodiment, when the random number of the board itself is less than the random number of the counterpart board, each of the first and second boards 21 and 22 may set the board itself to a master board and when the random number of the board itself is greater than the random number of the counterpart board, set the board itself to a slave board. In addition, although the probability is very low, when two random numbers are equal to each other, it is possible to arbitrarily set one of the first and second boards 21 and 22 to a master board.

As described above, in the present invention, the number of clocks is counted individually in duplexed boards having the same configuration and functions, and a board in which a faster clock is counted is set to a master board and a counterpart board is set to a slave board. This method has the advantage of being able to quickly set a master board in a simple way through communication between the boards.

In the above description, although it is described that all the components constituting the embodiment of the present invention are integrally combined or operated in combination, the present invention is not necessarily limited to such an embodiment. That is, within the scope of the present invention, all of the components may be operated in at least one selective combination. In addition, the terms “comprise”, “constitute”, or “have” described above mean that corresponding components may be included unless specifically stated otherwise. Accordingly, it should be construed that other components are not excluded, but may further be included. All terms including technical and scientific terms have the same meanings as commonly understood by those skilled in the art unless otherwise defined. Such terms as those defined in a generally used dictionary are to be interpreted as having meanings equal to the contextual meanings in the relevant field of art, and are not to be interpreted as having ideal or excessively formal meanings unless clearly defined as having such in the present invention.

The above description is merely illustrative of the technical idea of the present invention, and various modifications and variations may be made without departing from the essential characteristics of the present invention by those skilled in the art to which the present invention pertains. Accordingly, the embodiment disclosed in the present invention is not intended to limit the technical idea of the present invention but to describe the present invention, and the scope of the technical idea of the present invention is not limited by the embodiment. The scope of protection of the present invention should be interpreted by the following claims, and all technical ideas within the scope equivalent thereto should be construed as being included in the scope of the present invention.

1. A duplexed board comprising:
a clock generator configured to generate a clock when power is supplied in initial booting;
a clock counter configured to count a number of clocks generated by the clock generator;
a communication unit configured to transmit the counted number of clocks to a counterpart board and receive a number of clocks of the counterpart board from the counterpart board; and
a control unit configured to set, to a master board, a board having a larger number of clocks among the two numbers of clocks transmitted and received on each clock through the communication unit.

2. The duplexed board of claim 1, wherein the communication unit transmits the number of clocks of the board itself to the counterpart board on each clock generated by the clock generator.

3. The duplexed board of claim 1, further comprising a random number generator configured to generate a random number, wherein the random number generator generates a random number when the two numbers of clocks transmitted and received are equal to each other for a predetermined time, and the communication unit transmits the random number to the counterpart board and receives a random number from the counterpart board, and the control unit sets a master/slave board by comparing the two random numbers transmitted and received.

4. The duplexed board of claim 3, wherein the control unit sets a board which has generated a larger random number as a result of comparing the two random numbers, to a master board.

5. The duplexed board of claim 1, wherein the number of clocks has a digital value composed of 1 and 0, and the communication unit alternately transmits and receives the digital value of the number of clocks alternately with the counterpart board by one bit.

6. The duplexed board of claim 5, wherein, when the digital values of the two numbers of clocks are transmitted and received, the control unit sets a master and a slave board according to the following conditions:
when A=B=1 or A=B=0, setting of master/slave board is suspended,
when A=1, B=0, setting of the board itself to a master board is performed, and
when A=0, B=1, setting of the board itself to a slave board is performed.
(A is a digital value of 1 bit transmitted to the counterpart board, and B is a digital value of 1 bit received from the counterpart board).

7. The duplexed board of claim 6, wherein the control unit transmits and receives a next digital value of 1 bit among the digital values of the number with the counterpart board through the communication unit and sets a master board or a slave board according to the conditions when A=B=1 or A=B=0.

8. A method of setting duplexed boards to master/slave, the method comprising:
simultaneously inputting power to first and second boards which are duplexed in initial booting;
generating, by the first and second boards, clocks individually when the power is input;
counting, by each of the first and second boards, a number of the generated clocks when the power is input;
transmitting, by each of the first and second boards, the counted number of clocks to a counterpart board and receiving a number of clocks counted by the counterpart board from the counterpart board on each clock generated; and
comparing, by each of the first and second boards, the numbers of clocks transmitted and received on each clock, setting the board itself to a master board when the number of clocks of the broad itself is greater than that of the slave board, and setting the board itself to a slave board when the number of clocks of the broad itself is less than that of the slave board.

9. The method of claim 8, further comprising:
generating, by each of the first and second boards, a random number when the two numbers of clocks transmitted and received are equal to each other for a predetermined time as a result of the comparison;
transmitting, by each of the first and second boards, a random number of the board itself to the counterpart board and receiving a random number generated by the counterpart board from the counterpart board; and
comparing, by each of the first and second boards, the two random numbers that are transmitted and received and setting the board itself to a master board or a slave board.

10. The method of claim 9, wherein each of the first and second boards sets the board itself to a master board when the random number generated by the board itself is greater than the random number of the counterpart board and sets the board itself to a slave board when the random number generated by the board itself is less than the random number of the counterpart board.

11. The method of claim 9, wherein each of the first and second boards sets the board itself to a master board when the random number generated by the board itself is less than the random number of the counterpart board and sets the board itself to a slave board when the random number generated by the board itself is greater than the random number of the counterpart board.

12. The master of claim 8, wherein the number of clocks has a digital value composed of 1 and 0, and the communication unit alternately transmits and receives the digital value of the number of clocks alternately with the counterpart board by one bit sequentially.

13. The method of claim 12, wherein, when the digital values of the two numbers of clocks are transmitted and received, the first and second boards set the master board and the slave board according to the following conditions.
when A=B=1 or A=B=0, setting of master/slave board is suspended,
when A=1, B=0, setting of the first board to a master board and the second board to a slave board is performed, and
when A=0, B=1, setting of the first board to a slave board and the second board to a master board is performed.
(A is a digital value of 1 bit transmitted to the counterpart board, and B is a digital value of 1 bit received from the counterpart board).

14. The method of claim 13, wherein the control unit transmits and receives a next digital value of 1 bit among the digital values of the number with the counterpart board through the communication unit and sets a master board or a slave board according to the conditions when A=B=1 or A=B=0.
